(19) United States
(12) Patent Application Publication
(10) Pub. No.: US 2018/0121745 A1
(43) Pub. Date: May 3, 2018

(54) APPARATUS, METHOD FOR OBJECT IDENTIFICATION, AND NON-TRANSITORY COMPUTER-READABLE STORAGE MEDIUM

(71) Applicant: FUJITSU LIMITED, Kawasaki-shi (JP)

(72) Inventors: Kazuki Osamura, Kawasaki (JP); Taichi Murase, Kawasaki (JP); Yusaku Fujii, Shinjuku (JP)

(73) Assignee: FUJITSU LIMITED, Kawasaki-shi (JP)

(21) Appl. No.: 15/724,313

(22) Filed: Oct. 4, 2017

(30) Foreign Application Priority Data
Oct. 28, 2016 (JP) 2016-212047

(51) Int. Cl. G06K 9/34; G06K 9/00; G06K 9/62; G06K 9/46

(52) U.S. Cl. CPC G06K 9/34; G06K 9/4604; G06K 9/6202; G06K 9/00382

(57) ABSTRACT

An apparatus for object identification includes: a memory; and a processor coupled to the memory and configured to execute a determination process that includes determining whether a hand is in contact with an object, execute an identification process that includes identifying a first shape of an area of the object hidden by the hand in accordance with a second shape of the hand when the hand is determined to be in contact with the object in the determination process, and execute a distinguishing process that includes distinguishing the object based on the first shape in the identification process.

### CROSS-REFERENCE TO RELATED APPLICATION

This application is based upon and claims the benefit of priority of the prior Japanese Patent Application No. 2016-212047, filed on Oct. 28, 2016, the entire contents of which are incorporated herein by reference.

### FIELD

The embodiments discussed herein are related to an apparatus, a method for object identification, and a non-transitory computer-readable storage medium for storing a program for object identification.

### BACKGROUND

In the related art, a projector camera system is known in which a user interacts with an object using a hand. The projector camera system estimates a change in the state of an object that is an operation target by distinguishing the object and grasping an operation that has been performed on the distinguished object by the user, and projects an image corresponding to the estimation result.

For example, a case in which the projector camera system is installed in a restaurant or the like is described below. In the restaurant or the like, a user performs an operation to hold and tilt an object (for example, a glass) by the hand in order to drink a beverage in the glass. The projector camera system may estimate a change in the state of the glass (remaining amount of the content) by grasping the operation and calculating the tilt of the glass. As a result, in the projector camera system, an image desired for additional order may be provided for the user at appropriate timing, for example.

Examples of the related art include Japanese Laid-open Patent Publication No. 2001-282456.

### SUMMARY

According to an aspect of the invention, an apparatus for object identification includes: a memory; and a processor coupled to the memory and configured to execute a determination process that includes determining whether a hand is in contact with an object, execute an identification process that includes identifying a first shape of an area of the object hidden by the hand in accordance with a second shape of the hand when the hand is determined to be in contact with the object in the determination processing, and execute a distinguishing process that includes distinguishing the object based on the first shape in the identification process.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIGS. 1A and 1B are diagrams illustrating an application example of a projector camera system;

FIG. 2 is a diagram illustrating an example of a system configuration of the projector camera system;

FIG. 3 is a diagram illustrating an example of a hardware configuration of an information processing apparatus;

FIG. 4 is a diagram illustrating an example of a basic shape table;

FIG. 5 is a diagram illustrating an example of a hand model table;

FIG. 6 is a diagram illustrating an example of a handle model table;

FIG. 7 is a diagram illustrating an example of an object model table;

FIG. 8 is a diagram illustrating an example of a functional configuration of an object distinguishing unit;

FIGS. 9A and 9B are diagrams illustrating the outline of object distinguishing processing at the time when a hand is not in contact with an object;

FIG. 10 is a diagram illustrating examples of an object distinguishing result, location information, and angle information at the time when the hand is not in contact with an object;

FIGS. 11A and 11B are diagrams illustrating the outline of the object distinguishing processing at the time when the hand is in contact with an object;

FIG. 12 is a diagram illustrating the overview of hidden object shape identification processing;

FIG. 13 is a diagram illustrating the overview of combination processing;

FIG. 14 is a diagram illustrating examples of an object distinguishing result, location information, and angle information at the time when the hand is in contact with an object;

FIG. 15 is a first flowchart of the object distinguishing processing; and

FIG. 16 is a second flowchart of the object distinguishing processing.

### DESCRIPTION OF EMBODIMENTS

In the above-described projector camera system, when a change in the state of the object that is the operation target is estimated, it is desirable that the object held by the hand is correctly distinguished based on the shape and the like of the object, and pieces of information such as the location, the angle, and the like of the object are calculated accurately.

However, in the case of the object held by the hand, a part of the object is hidden by the hand, so that it is difficult to correctly distinguish the object.

According to an aspect of an embodiment, provided are technologies for being able to identify an object even when a part of the object is hidden by a hand.

Embodiments of the technology are described below with reference to accompanying drawings. In the specification and the drawings of the technology discussed herein, by applying the same symbol to configuration elements having a substantially same functional configuration, a duplicated description is omitted.

### First Embodiment

<Application Example of a Projector Camera System>

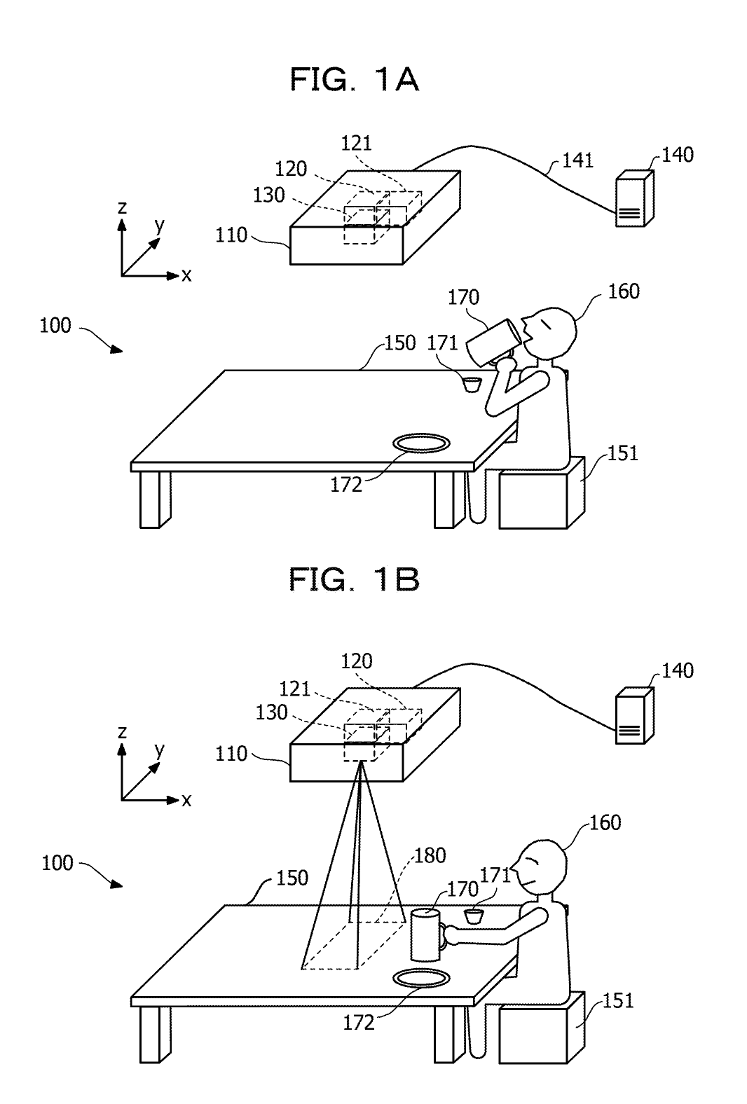

First, an example when a projector camera system according to a first embodiment is applied to automatic display of a menu in a store such as a restaurant is described. FIGS. 1A and 1b are diagrams illustrating an application example of the projector camera system.

As illustrated in FIGS. 1A and 1B, a projector camera system 100 includes a distance measurement apparatus 120, an imaging apparatus 121, a projector apparatus 130, and an information processing apparatus 140 that is an example of an object distinguishing apparatus. The object distinguishing apparatus may be referred to as an object identification apparatus. The distance measurement apparatus 120, the imaging apparatus 121, and the projector apparatus 130 are coupled to the information processing apparatus 140 through a communication cable 141 so as to communicate with the information processing apparatus 140. The distance measurement apparatus 120, the imaging apparatus 121, and the projector apparatus 130 are provided in a housing 110 of a lighting device attached to the ceiling of the store.

A table 150 and a chair 151 are placed in the store, and a user 160 receives a provision of food service in the store. In the example of FIG. 1A, a scene is illustrated in which various food containers (objects such as a glass 170, a small bowl 171, and a small dish 172) are placed on the table 150, and the user 160 drinks a beverage in the glass 170.

The distance measurement apparatus 120 measures a specific area including the upper surface of the table 150 as a measurement range and generates distance image data. Similarly, the imaging device 121 captures the specific area including the upper surface of the table 150 as an imaging range and generates RGB image data. In addition, the projector apparatus 130 projects projection image data onto the upper surface of the table 150 as a projection range.

In the first embodiment, a specific reference point in a space in which the projector camera system 100 is installed in the store is set as an origin point, and a surface parallel to the upper surface of the table 150 is set as an xy plane, and an axis orthogonal to the xy plane is set as a z axis. As a result, a certain location in the space in which the projector camera system 100 is installed in the store is identified by an x coordinate, a y coordinate, and a z coordinate.

In the case of the projector camera system 100, even in a state in which the glass 170 is held by the hand of the user 160, the shape of an area hidden by the hand may be identified. Therefore, in the projector camera system 100, the glass 170 may be correctly distinguished in real time. As a result, in the projector camera system 100, the tilt of the glass 170 may be accurately calculated, and the state of the glass 170 (the state in which the remaining amount of the beverage in the glass 170 has become empty) may be estimated in real time.

FIG. 1B illustrates a state in which the user 160 puts the glass 170 back on the table 150 immediately after the projector camera system 100 has estimated that the remaining amount of the beverage in the glass 170 has become zero.

In the projector camera system 100, when the state of the object (the state in which the remaining amount of the beverage in the glass 170 has become zero) is estimated, projection image data 180 corresponding to the state of the object is projected onto the table 150 through the projector apparatus 130. The projection image data 180 corresponding to the state of the object is, for example, projection image data including a menu used to perform additional order of alcohols when the beverage in the glass 170 corresponds to alcohols.

<System Configuration of the Projector Camera System>

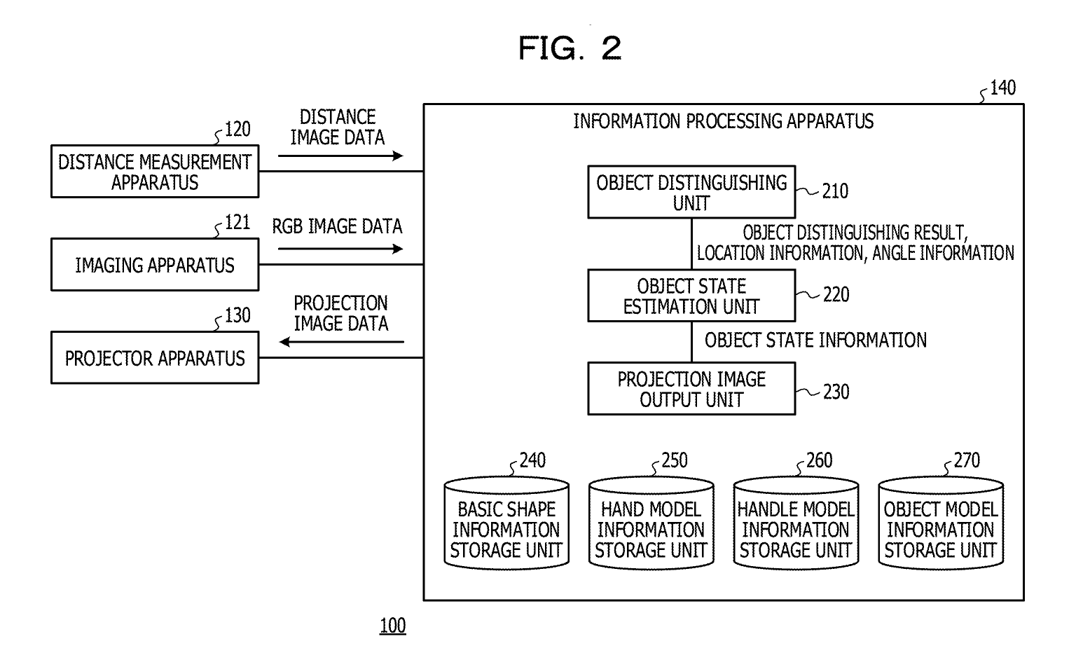

A system configuration of the projector camera system 100 is described below. FIG. 2 is a diagram illustrating an example of the system configuration of the projector camera system.

As illustrated in FIG. 2, the distance image data that has been measured by the distance measurement apparatus 120 is input to the information processing apparatus 140. Similarly, the RGB image data that has been captured by the imaging apparatus 121 is input to the information processing apparatus 140. Coordinates (x, y, and z coordinates) indicating a location in the space, which is identified by each pixel in the distance image data, and coordinates (x, y, and z coordinates) indicating a location in the space, which is identified by each pixel in the RGB image data, are adjusted so as to match with each other.

The projection image data from the information processing apparatus 140 is input to the projector apparatus 130, and is projected onto the upper surface of the table 150 by the projector apparatus 130.

An object distinguishing program, an object state estimation program, and a projection image output program are installed in the information processing apparatus 140. The information processing apparatus 140 functions as an object distinguishing unit 210, an object state estimation unit 220, and a projection image output unit 230 by executing these programs, respectively. The object distinguishing program and the object distinguishing unit 210 may be referred to as an object identification program and an object identification unit 210, respectively.

The object distinguishing unit 210 identifies a hand model and calculates the state amount of the hand model by detecting the hand of the user 160 based on the distance image data and the RGB image data and referring to a hand model table stored in a hand model information storage unit 250. The state amount of the hand model is location information indicating the location and angle information indicating the angle of bones included in the hand model.

In addition, the object distinguishing unit 210 detects objects placed on the table 150 based on the distance image data and the RGB image data. The object distinguishing unit 210 determines whether the hand of the user 160 is in contact with any one of the detected objects in a specific state, (for example, a state in which the object is held by the hand), based on the locations of the detected objects and the location of the identified hand model.

When the object distinguishing unit 210 determines that the hand of the user 160 is not in contact with any one of the detected objects in the specific state, the object distinguishing unit 210 refers to a basic shape table stored in a basic shape information storage unit 240 and an object model table stored in an object model information storage unit 270. As a result, the object distinguishing unit 210 distinguishes the detected objects. In addition, the object distinguishing unit 210 associates the object distinguishing result at the time when the hand is not in contact with any one of the objects with pieces of location information indicating the locations and pieces of angle information indicating the angles of the object and notifies the object state estimation unit 220 of the associated result and pieces of information. The object distinguishing result may be referred to as an object identification result.

In addition, when the object distinguishing unit 210 determines that the hand of the user 160 is in contact with any one of the detected objects in the specific state, the object distinguishing unit 210 identifies the shape of an area of the object hidden by the hand, by comparing the hand model at the time when the hand is in contact with the object and a shape candidate of the area of the object hidden by the hand.

In the first embodiment, it is assumed that the area hidden by the hand corresponds to a handle of the glass 170. Specifically, the object distinguishing unit 210 reads various handle models from a handle model table stored in a handle model information storage unit 260, as the shape candidates of the area hidden by the hand. In addition, the object distinguishing unit 210 identifies a handle model by comparing the shapes of the read various handle models with the hand shape calculated based on the state amount of the hand model.

In addition, the object distinguishing unit 210 distinguishes the object by combining the shape of the object that has been detected at the time when the hand is in contact with the object (the shape of an area of the object, which is not hidden by the hand) with the handle model that has been identified at the time when the hand is in contact with the object and comparing the combination result with the object model table stored in the object model information storage unit 270. In addition, the object distinguishing unit 210 associates the object distinguishing result at the time when the hand is in contact with the object with the location information indicating the location and the angle information indicating the angle of the object, and notifies the object state estimation unit 220 of the associated object distinguishing result and pieces of information.

The object state estimation unit 220 obtains an object distinguishing result, location information, and angle information at the time when the hand is not in contact with the object or not in contact with the object, from the object distinguishing unit 210. In addition, the object state estimation unit 220 estimates the state of the object, based on the obtained object distinguishing result, location information, and angle information, and notifies the projection image output unit 230 of the estimation result as object state information.

The projection image output unit 230 obtains the object state information from the object state estimation unit 220. In addition, the projection image output unit 230 selects projection image data that is to be transmitted to the projector apparatus 130, based on the obtained object state information. In addition, the projection image output unit 230 transmits the selected projection image data to the projector apparatus 130.

As a result, the projector apparatus 130 may project projection image data corresponding to the states of the various objects on the table 150 onto the upper surface of the table 150.

<Hardware Configuration of the Information Processing Apparatus>

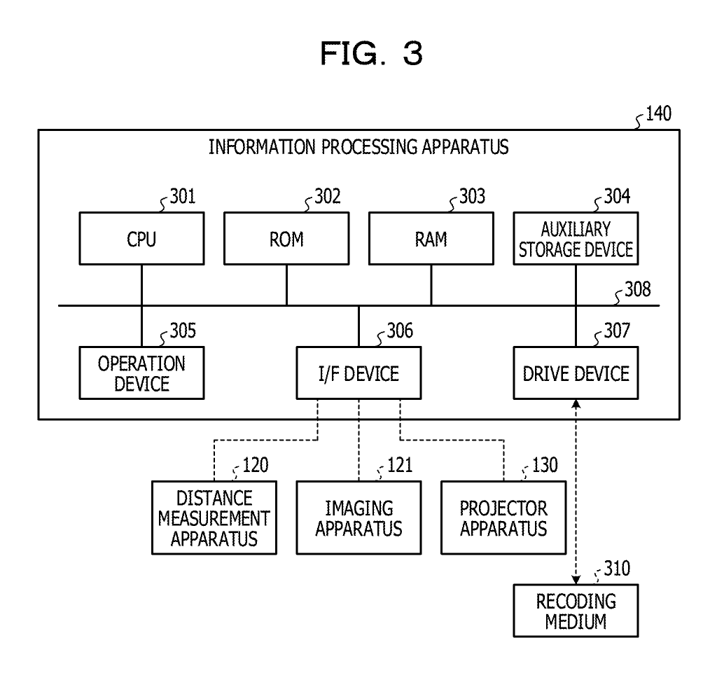

A hardware configuration of the information processing apparatus 140 is described below. FIG. 3 is a diagram illustrating an example of the hardware configuration of the information processing apparatus.

As illustrated in FIG. 3, the information processing apparatus 140 includes a central processing unit (CPU) 301, a read only memory (ROM) 302, a random access memory (RAM) 303, and an auxiliary storage device 304. In addition, the information processing apparatus 140 includes an operation device 305, an interface (I/F) device 306, and a drive device 307. These units in the information processing apparatus 140 are coupled to each other through a bus 308.

The CPU 301 is a computer that executes various programs installed in the auxiliary storage device 304 (for example, the object distinguishing program, the object state estimation program, the projection image output program, and the like). The ROM 302 is a nonvolatile memory. The ROM 302 functions as a main storage device that stores various programs, pieces of data, and the like desired when the CPU 301 executes the various programs stored in the auxiliary storage device 304. Specifically, the ROM 302 stores boot programs such as a basic input/output system (BIOS) and an extensible firmware interface (EFI).

The RAM 303 is a volatile memory such as a dynamic random access memory (DRAM) or a static random access memory (SRAM), and functions as a main storage device. The RAM 303 provides a work area to which the various programs stored in the auxiliary storage device 304 are deployed when the CPU executes the various programs.

The auxiliary storage device 304 stores the various programs, pieces of information generated when the various programs are executed, and pieces of information used when the various programs are executed. The basic shape information storage unit 240, the hand model information storage unit 250, the handle model information storage unit 260, and the object model information storage unit 270 are realized by the auxiliary storage device 304.

The operation device 305 is a device used when an administrator of the information processing apparatus 140 inputs various instructions to the information processing apparatus 140.

The I/F device 306 is a device used to couple the distance measurement apparatus 120, the imaging apparatus 121, and the projector apparatus 130 to the information processing apparatus 140 through the communication cable 141 so that the distance measurement apparatus 120, the imaging apparatus 121, and the projector apparatus 130 may communicate with the information processing apparatus 140.

The drive device 307 is a device to which a recording medium 310 is set. Here, an example of the recording medium 310 includes a medium in which information is recorded optically, electrically, or magnetically such as a compact disc-read-only memory (CD-ROM), a flexible disk, or a magneto-optical disk. In addition, the example of the recording medium 310 also includes a semiconductor memory or the like in which information is electrically recorded such as a ROM or a flash memory.

The various programs stored in the auxiliary storage device 304 are installed, for example, when the distributed recording medium 310 is set to the drive device 307, and the various programs recorded in the recording medium 310 are read by the drive device 307.

<Tables Stored in the Various Information Storage Units>

Tables stored in the various information storage units (the basic shape information storage unit 240, the hand model information storage unit 250, the handle model information storage unit 260, and the object model information storage unit 270) are described below.

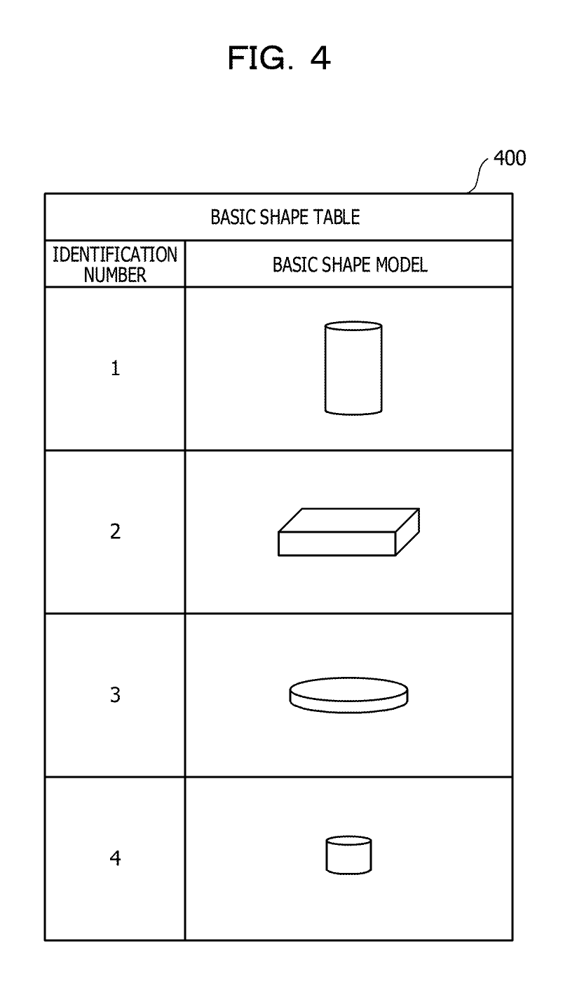

First, a basic shape table stored in the basic shape information storage unit 240 is described. FIG. 4 is a diagram illustrating an example of the basic shape table. As illustrated in FIG. 4, a basic shape table 400 includes “identification number” and “basic shape model” as items of pieces of information.

In “identification number”, an identifier used to identify a basic shape model is stored. In “basic shape model”, a model having a basic shape used to detect an object placed on the table 150 is stored. In the example of FIG. 4, a model having a cylindrical shape the size of which is medium is stored so as to be associated with an identification number 1. In addition, a model having a rectangular solid shape the size of which is large, a model having a disk shape the size of which is large, and a model having a cylindrical shape the size of which is small are stored so as to be associated with identification numbers 2, 3, and 4, respectively. The basic shape table 400 illustrated in FIG. 4 is an example, and in the basic shape table 400, a basic shape model other than the models illustrated in FIG. 4 may be stored.

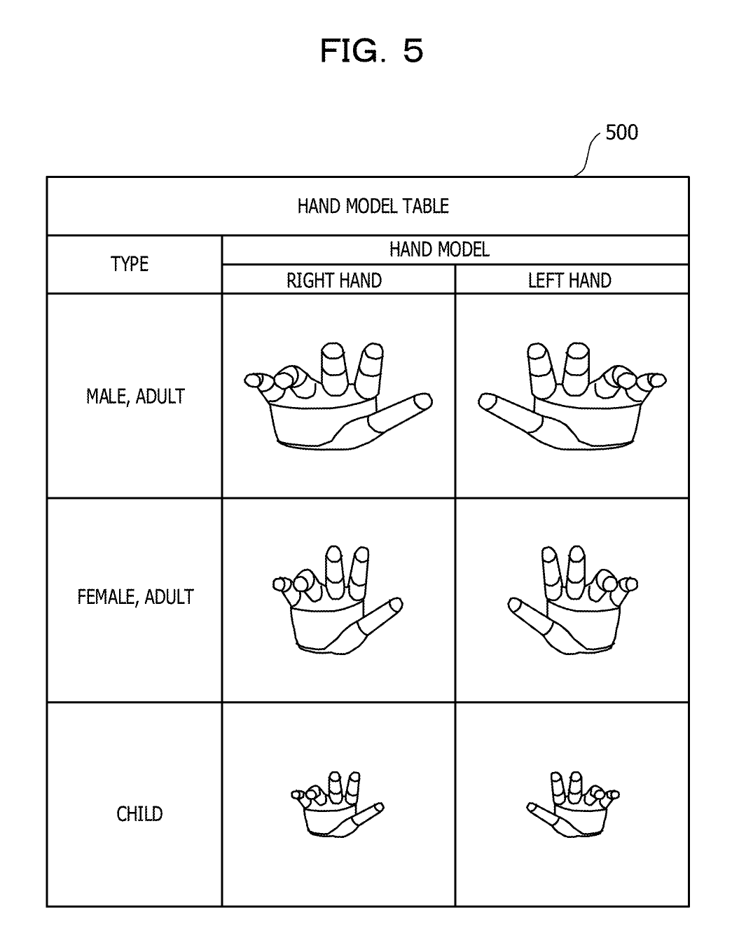

A hand model table stored in the hand model information storage unit 250 is described below. FIG. 5 is a diagram illustrating an example of the hand model table. As illustrated in FIG. 5, a hand model table 500 includes “type” and “hand model” as items of pieces of information.

In “type”, information indicating the type of a hand model is stored. In the first embodiment, hand models are stored so as to be classified into three types based on the thicknesses, the lengths, and the shapes of the hands. Specifically, the hand models are stored so as to be classified into three types of a male adult hand model, a female adult hand model, and a child hand model.

Here, “hand model” further includes “right hand” and “left hand” as items of pieces of information, and in “right hand”, a hand model of a right hand of a corresponding type is stored. In addition, in “left hand”, a hand model of a left hand of a corresponding type is stored.

As described above, the hand model includes a plurality of bones, and “state amount” indicating the location and the angle of each of the bones is calculated based on the distance image data of the area of the hand.

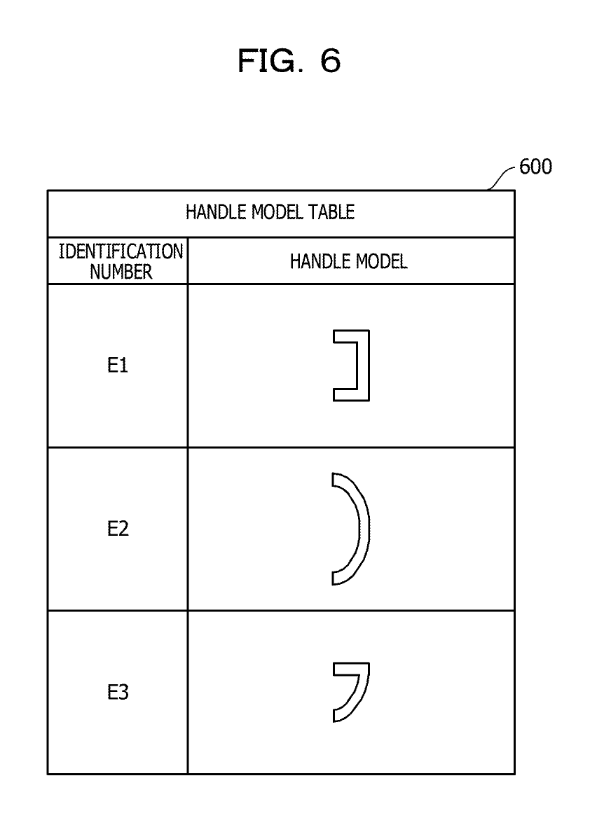

A handle model table stored in the handle model information storage unit 260 is described below. FIG. 6 is a diagram illustrating an example of the handle model table. As illustrated in FIG. 6, a handle model table 600 includes “identification number” and “handle model” as items of pieces of information.

In “identification number”, an identifier used to identify a handle model is stored. In “handle model”, a model indicating the shape of a handle that is a part of an object placed on the table 150 is stored.

As illustrated in FIG. 6, in the first embodiment, in the handle model table 600, a square handle model having an identification number El, a round shape handle model having an identification number E2, and a coffee cup handle model having an identification number E3 are stored.

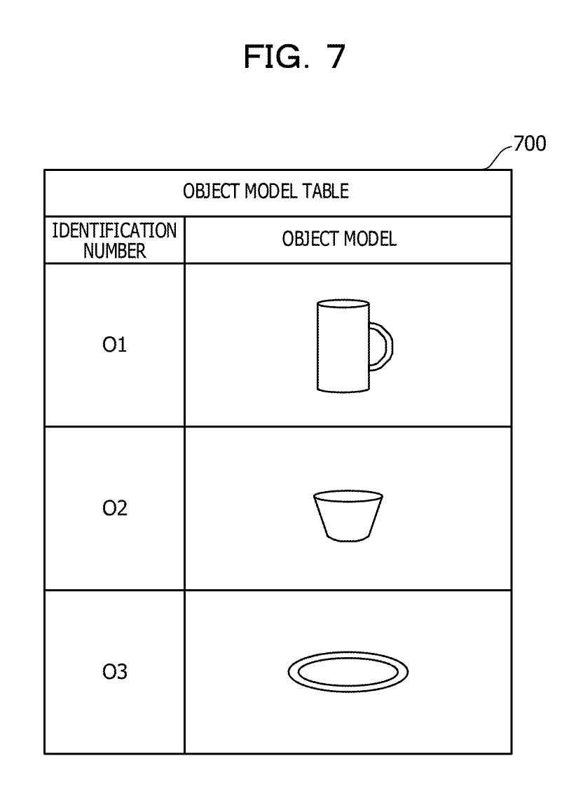

An object model table stored in the object model information storage unit 270 is described below. FIG. 7 is a diagram illustrating an example of the object model table. As illustrated in FIG. 7, an object model table 700 includes “identification number” and “object model” as items of pieces of information.

In “identification number”, an identifier used to identify an object model is stored. In “object model”, a model indicating the shape of an object placed on the table 150 is stored. Specifically, in “object model”, an object model indicating the glass 170 is stored so as to be associated with an identification number O1. In addition, in “object model”, an object model indicating the small bowl 171 is stored so as to be associated with an identification number O2. In addition, in “object model”, an object model indicating the small dish 172 is stored so as to be associated with an identification number O3.

<Functional Configuration of the Object Distinguishing Unit>

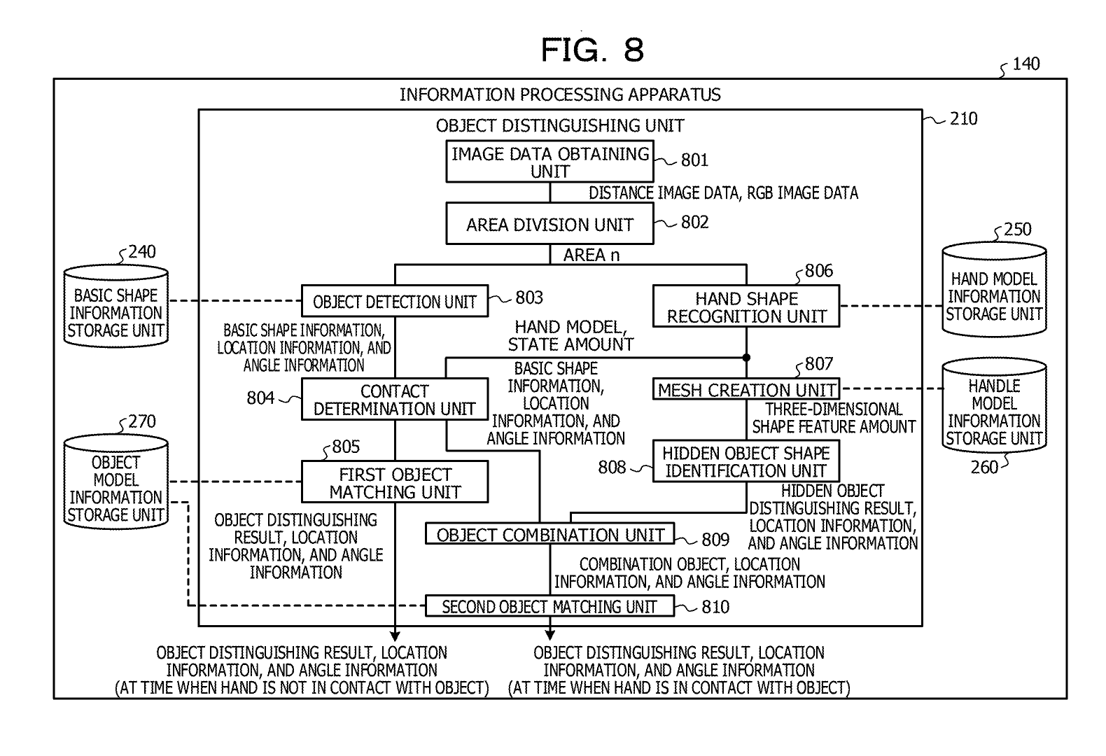

A functional configuration of the object distinguishing unit 210 is described below. FIG. 8 is a diagram illustrating an example of the functional configuration of the object distinguishing unit. As illustrated in FIG. 8, the object distinguishing unit 210 includes an image data obtaining unit 801, an area division unit 802, an object detection unit 803, a contact determination unit 804, and a first object matching unit 805. In addition, the object distinguishing unit 210 further includes a hand shape recognition unit 806, a mesh creation unit 807, a hidden object shape identification unit 808, an object combination unit 809, and a second object matching unit 810.

The image data obtaining unit 801 obtains each of the distance image data that has been measured by the distance measurement apparatus 120 and the RGB image data that has been captured by the imaging apparatus 121 at specific intervals. The image data obtaining unit 801 notifies the area division unit 802 of the obtained distance image data and RGB image data.

The area division unit 802 detects objects and a hand, based on the RGB image data that has been notified from the image data obtaining unit 801, and extracts areas of the detected objects and hand. The area division unit 802 extracts, for example, an area in which a difference with an RGB value of the upper surface of the table 150 is a specific value or more as an area of the object, in the RGB image data. In addition, the area division unit 802 extracts, for example, an area having a specific color (flesh color) in the RGB image data as an area of the hand. In addition, the area division unit 802 extracts areas of the distance image data at the locations corresponding to the extracted areas, respectively.

The area division unit 802 notifies the object detection unit 803 of the area including the object, which has been extracted from the distance image data. In addition, the area division unit 802 notifies the hand shape recognition unit 806 of the area including the hand, which has been extracted from the distance image data.

The object detection unit 803 compares the shape of the object in the area, which is identified based on the distance image data of the area that has been notified from the area division unit 802 with each of the basic shape models included in the basic shape table 400. As a result, the object detection unit 803 recognizes the shape of the object of the area as a combination of the basic shape models. In addition, the object detection unit 803 calculates location information indicating the location and angle information indicating the angle of the recognized combination of the basic shape models.

In addition, the object detection unit 803 notifies the contact determination unit 804 of the recognized combination of the basic shape models as basic shape information. In addition, the object detection unit 803 notifies the contact determination unit 804 of the calculated location information and angle information.

The hand shape recognition unit 806 compares the hand in the area, which is identified based on the distance image data of the area that has been notified from the area division unit 802 with each of the hand models included in the hand model table 500, based on the thickness, the length, the shape, and the like of the hand. As a result, the hand shape recognition unit 806 extracts a hand model that is the most similar to the hand in the area (the thickness, the length, the shape, and the like of the hand), and calculates the state amount of the hand model based on the location and the posture of the hand, and the angles of the joints.

The hand shape recognition unit 806 notifies the contact determination unit 804 of the extracted hand model and the calculated state amount. In addition, after the notification, when the hand shape recognition unit 806 obtains a determination result indicating that the hand of the user 160 is in contact with any one of the objects on the table 150 in a specific state, from the contact determination unit 804, the hand shape recognition unit 806 notifies the mesh creation unit 807 of the hand model and the state amount.

The contact determination unit 804 is an example of a determination unit, and determines whether the hand of the user 160 is in contact with any one of the objects on the table 150 in the specific state. Specifically, the contact determination unit 804 compares the location information and the angle information that have been associated with the basic shape information that has been notified from the object detection unit 803, with the state amount of the hand model that has been notified from the hand shape recognition unit 806. As a result, the contact determination unit 804 determines whether the hand of the user 160 is in contact with any one of the objects on the table 150 in the specific state.

For example, the contact determination unit 804 determines the presence or absence of the contact by determining whether the hand model is positioned in a range obtained by the location information and the angle information that have been associated with the basic shape information.

In addition, the contact determination unit 804 determines whether the hand of the user 160 is in the specific state (state in which the object is held by the hand), based on the state amount of the hand model when the contact determination unit 804 determines that the hand is in contact with any one of the objects. The contact determination unit 804 determines that the hand of the user 160 is in the specific state (state in which the object is held by the hand), for example, when a specific bone included in the hand model is moved in respect to another bone by a specific angle or more.

When the contact determination unit 804 determines that the hand of the user 160 is not in contact with any one of the objects in the specific state, the contact determination unit 804 notifies the first object matching unit 805 of the basic shape information, the location information, and the angle information.

In addition, when the contact determination unit 804 determines that the hand of the user 160 is in contact with any one of the objects in the specific state, the contact determination unit 804 notifies the object combination unit 809 of the basic shape information, the location information, and the angle information. In addition, when the contact determination unit 804 determines that the hand of the user 160 is in contact with any one of the objects in the specific state, the contact determination unit 804 notifies the hand shape recognition unit 806 of the determination result.

The first object matching unit 805 compares the basic shape information that has been notified from the contact determination unit 804 with each of the object models included in the object model table 700. As a result, the first object matching unit 805 extracts an object model that is the most similar to the basic shape information as an object distinguishing result. The first object matching unit 805 compares the shape identified by the basic shape information (it is assumed that the shape is represented by a point cloud) with the shape identified by the object model (it is assumed the shape is represented by a point cloud). In addition, the first object matching unit 805 extracts an object model that is the most similar to the basic shape information (object model in which the distance with the corresponding point cloud of the shape of the basic shape information is the shortest), as an object distinguishing result.

In addition, the first object matching unit 805 extracts location information indicating the location and angle information indicating the angle of the object model when the first object matching unit 805 determines that the extracted object model is the most similar to the basic shape information. In addition, the first object matching unit 805 outputs the object distinguishing result, the location information, and the angle information to the object state estimation unit 220 as an object distinguishing result, location information, and angle information of the object with which the hand of the user 160 is not in contact.

The mesh creation unit 807 obtains the hand model that has been extracted by the hand shape recognition unit 806 and the state amount that has been calculated by the hand shape recognition unit 806. In addition, the mesh creation unit 807 creates Delaunay triangles by connecting end parts of bones included in the hand model (bone points) by line segments and creates a three-dimensional mesh of the hand model. In addition, the mesh creation unit 807 identifies the shape of the inside surface of the hand model (inside surface that is in contact with the object) and calculates a three-dimensional shape feature amount indicating the identified shape by representing the created three-dimensional mesh by a point cloud. The mesh creation unit 807 calculates, for example, a signature of histograms of orientations (SHOT) feature amount as the three-dimensional shape feature amount.

In addition, the mesh creation unit 807 identifies the shape of the outside surface of each of the handle models included in the handle model table 600 (outside surface that is in contact with the hand) by reading the handle models and representing the handle models by point clouds. In addition, the mesh creation unit 807 calculates a three-dimensional shape feature amount indicating the identified shape.

In addition, the mesh creation unit 807 notifies the hidden object shape identification unit 808 of the three-dimensional shape feature amount of the inside surface of the hand model and the three-dimensional shape feature amount of the outside surface of each of the handle models.

The hidden object shape identification unit 808 is an example of an identification unit, and extracts a handle model having an outside surface the shape of which is similar to the shape of the inside surface of the hand model as a hidden object distinguishing result by comparing the three-dimensional shape feature amounts that have been notified from the mesh creation unit 807.

The hidden object shape identification unit 808 extracts location information indicating the location and angle information indicating the angle of the extracted handle model when the hidden object shape identification unit 808 determines that the shape of the outside surface of the extracted handle model is the most similar to the shape of the inside surface of the hand model. In addition, the hidden object shape identification unit 808 notifies the object combination unit 809 of the extracted hidden object distinguishing result, location information, and angle information.

The object combination unit 809 generates a combination object by combining the basic shape information that has been notified from the contact determination unit 804 and the hidden object distinguishing result that has been notified from the hidden object shape identification unit 808, based on the pieces of location information and the pieces of angle information of the basic shape information and the hidden object distinguishing result. In addition, the object combination unit 809 associates combination object information indicating the combination object (basic shape model+handle model) with the pieces of location information and the pieces of angle information and notifies the second object matching unit 810 of the associated pieces of information.

The second object matching unit 810 is an example of a distinguishing unit, and compares the combination object information that has been notified from the object combination unit 809 with each of the object models included in the object model table 700. As a result, the second object matching unit 810 extracts an object model that is the most similar to the combination object information as an object distinguishing result. The second object matching unit 810 compares the shape identified by the combination object information (it is assumed that the shape is represented by a point cloud) with the shape identified by the object model (it is assumed that the shape is represented by a point cloud). In addition, the second object matching unit 810 extracts an object model that is the most similar to the combination object information (object model in which the distance with the corresponding point cloud of the shape of the combination object information is the shortest) as the object distinguishing result.

In addition, the second object matching unit 810 extracts location information indicating the location and angle information indicating the angle of the object model when the second object matching unit 810 determines that the extracted object model is the most similar to the combination object information. In addition, the second object matching unit 810 outputs the object distinguishing result, the location information, and the angle information to the object state estimation unit 220 as an object distinguishing result, location information, and angle information of the object with which the hand of the user 160 is in contact.

<Specific Example of the Processing by the Object Distinguishing Unit at the Time when the Hand is Not in Contact with an Object>

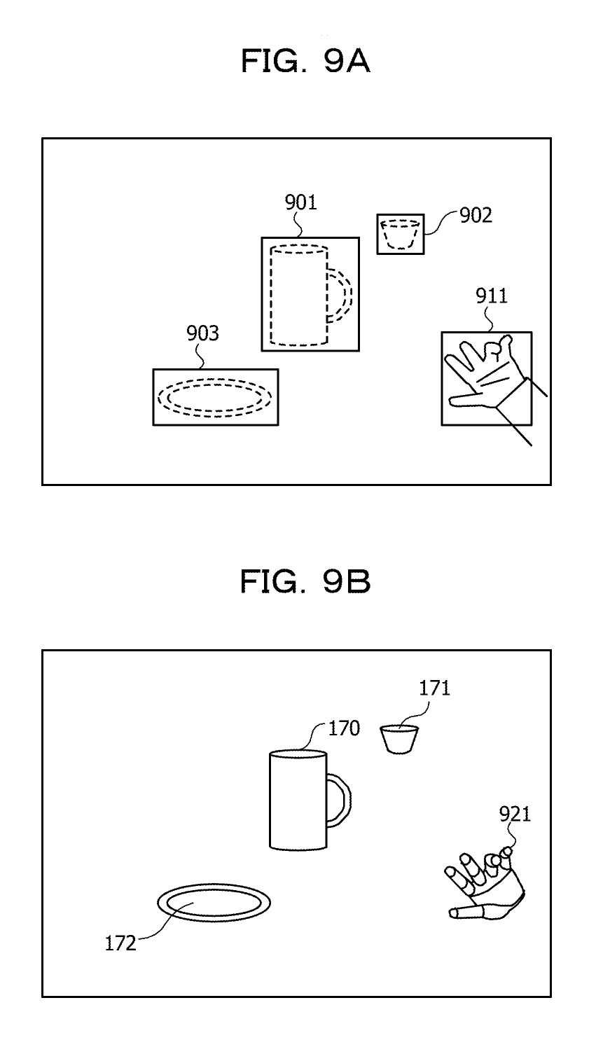

A specific example of the processing by the function units included in the object distinguishing unit 210 is described below. First, processing until output of an object distinguishing result for an object with which the hand of the user 160 is not in contact is performed by the function units included in the object distinguishing unit 210 is described. FIGS. 9A and 9B are diagrams illustrating the outline of the object distinguishing processing at the time when the hand is not in contact with an object. As illustrated in FIG. 1, the distance measurement apparatus 120 and the imaging apparatus 121 are installed above the table 150, so that distance image data and RGB image data are pieces of image data obtained by viewing the specific area including the upper surface of the table 150 from above the table 150. However, in the case of the image data viewed from above the table 150, it is difficult to see the three-dimensional shape of the object, so that, in the following description, for convenience, the object distinguishing processing is described using image data obtained by viewing the specific area including the upper surface of the table 150 at an oblique from above the table 150.

FIG. 9A illustrates a state in which the area division unit 802 detects objects and a hand based on RGB image data, and extracts areas of the detected objects and hand as areas 901 to 903 and an area 911, respectively.

FIG. 9B illustrates a state in which the hand shape recognition unit 806 extracts a hand model 921 based on distance image data of an area 911, and calculates the state amount of the hand model 921. When the hand shape recognition unit 806 calculates the state amount of the hand model 921, the contact determination unit 804 may determine whether the hand of the user 160 is in contact with any one of the objects in the areas 901 to 903 in a specific state.

In the case of the example illustrated in FIG. 9B, the hand of the user 160 is determined not to be in contact with any one of the objects in the areas 901 to 903 in the specific state. Therefore, the first object matching unit 805 extracts object models by pieces of basic shape information that have been notified from the object detection unit 803 based on distance image data of the areas 901 to 903. As a result, the first object matching unit 805 distinguishes the glass 170, the small bowl 171, and the small dish 172, and calculates pieces of location information indicating the locations and pieces of angle information indicating the angles of the glass 170, the small bowl 171, and the small dish 172, respectively.

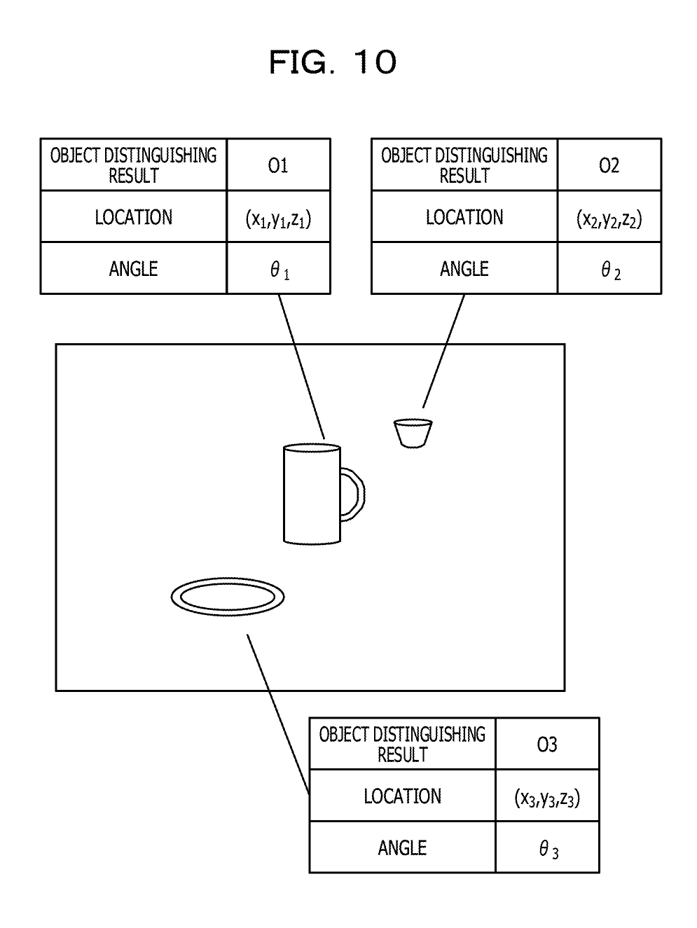

FIG. 10 is a diagram illustrating examples of an object distinguishing result, location information, and angle information at the time when the hand is not in contact with an object. As illustrated in FIG. 10, the first object matching unit 805 outputs distinguishing information O1 as an object distinguishing result of the glass 170. In addition, the first object matching unit 805 outputs “(x₁,y₁,z₁)” as location information of the glass 170 and outputs “θ1” as angle information of the glass 170.

Similarly, the first object matching unit 805 outputs distinguishing information O2 as an object distinguishing result of the small bowl 171. In addition, the first object matching unit 805 outputs “(x₂,y₂,z₂)” as location information of the small bowl 171, and outputs “θ2” as angle information of the small bowl 171. In addition, the first object matching unit 805 outputs distinguishing information O3 as an object distinguishing result of the small dish 172. In addition, the first object matching unit 805 outputs “(x₃,y₃,z₃)” as location information of the small dish 172, and outputs “θ3” as angle information of the small dish 172.

<Specific Example of the Processing by the Object Distinguishing Unit at the Time when the Hand is in Contact with an Object>

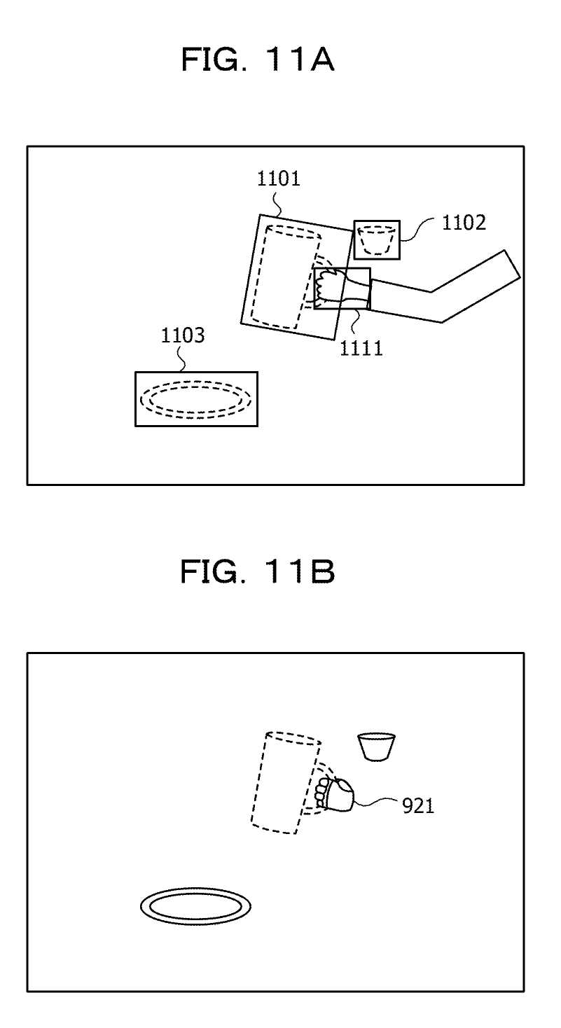

Processing until output of an object distinguishing result for an object with which the hand of the user 160 is in contact is performed by the function units included in the object distinguishing unit 210 is described below. FIGS. 11A and 11B are diagrams illustrating the outline of the object distinguishing processing at the time when the hand is in contact with the object.

FIG. 11A illustrates a state in which the area division unit 802 detects objects and a hand based on RGB image data and extracts areas of the detected objects and hand as areas 1101 to 1103, and 1111, respectively.

FIG. 11B illustrates a state in which the first object matching unit 805 extracts object models by the pieces of basic shape information that have been notified from the object detection unit 803, based on distance image data of the areas 1102 and 1103. As a result, the first object matching unit 805 distinguishes the small bowl 171 and the small dish 172 and calculates pieces of location information indicating the locations of the small bowl 171 and the small dish 172 and pieces of angle information indicating the angles of the small bowl 171 and the small dish 172.

In addition, FIG. 11B illustrates a state in which the hand shape recognition unit 806 extracts the hand model 921 based on distance image data of the area 1111 and calculates the state amount of the hand model 921. The contact determination unit 804 determines that the hand of the user 160 is in contact with the object in the area 1101 in the specific state, based on the state amount of the hand model 921, and the basic shape information, the location information, and the angle information that have been notified from the object detection unit 803 based on the distance image data of the area 1101. In this case, for the object in the area 1101, the second object matching unit 810 is notified of the basic shape information, the location information, and the angle information that have been notified from the object detection unit 803.

Here, when the contact determination unit 804 determines that the hand of the user 160 is in contact with the object in the area 1101 in the specific state, the mesh creation unit 807 and the hidden object shape identification unit 808 executes hidden object shape identification processing.

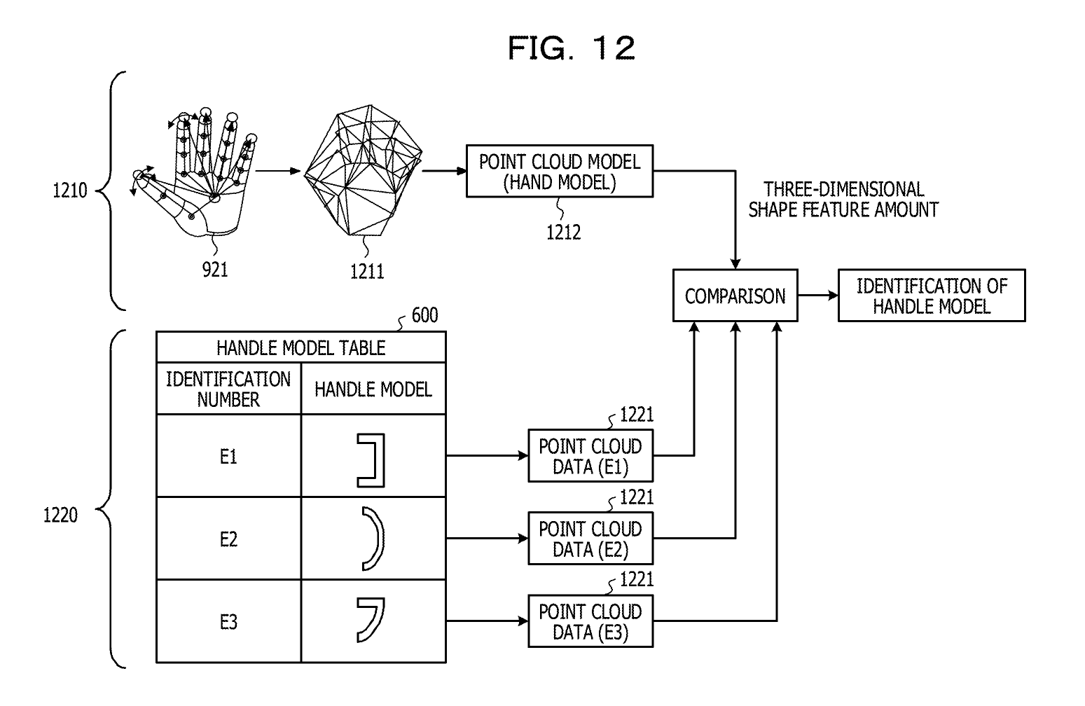

FIG. 12 is a diagram illustrating the overview of the hidden object shape identification processing. In the hidden object shape identification processing, processing 1210 indicates processing until the mesh creation unit 807 calculates a three-dimensional shape feature amount indicating the shape of the inside surface of the hand model 921.

When a determination result indicating that the hand of the user 160 is in contact with the object in the area 1101 in the specific state is obtained, the mesh creation unit 807 connects bone points included in the hand model 921 (circles in the hand model 921 illustrated in FIG. 12) by line segments, and creates Delaunay triangles. As a result, the mesh creation unit 807 creates a three-dimensional mesh 1211 of the hand model. In addition, the mesh creation unit 807 calculates point cloud data 1212 used to form the inside surface of the hand model by representing the created three-dimensional mesh 1211 by a point cloud. In addition, the mesh creation unit 807 calculates a three-dimensional shape feature amount indicating the shape of the inside surface of the hand model, based on the point cloud data 1212.

In addition, processing 1220 indicates processing until the mesh creation unit 807 calculates a three-dimensional shape feature amount indicating the shape of the outside surface of each of the handle models. When the processing 1210 is completed, the mesh creation unit 807 calculates pieces of point cloud data 1221 to 1223 respectively used to form the outside surfaces of the handle models included in the handle model table 600 by representing the handle models by point clouds. In FIG. 12, the point cloud data 1221 is point cloud data that has been calculated based on the handle model identified by the identification number E1. In addition, the point cloud data 1222 is point cloud data that has been calculated based on the handle model identified by the identification number E2. In addition, the point cloud data 1223 is point cloud data that has been calculated based on the handle model identified by the identification number E3. The mesh creation unit 807 calculates three-dimensional shape feature amounts indicating the shapes of the outside surfaces of the handle models, based on the pieces of point cloud data 1221 to 1223, respectively.

The hidden object shape identification unit 808 identifies a handle model having an outside surface the shape of which is similar to the shape of the inside surface of the hand model by comparing the three-dimensional shape feature amount that has been calculated in the processing 1210 with each of the three-dimensional shape feature amounts that have been calculated in the processing 1220.

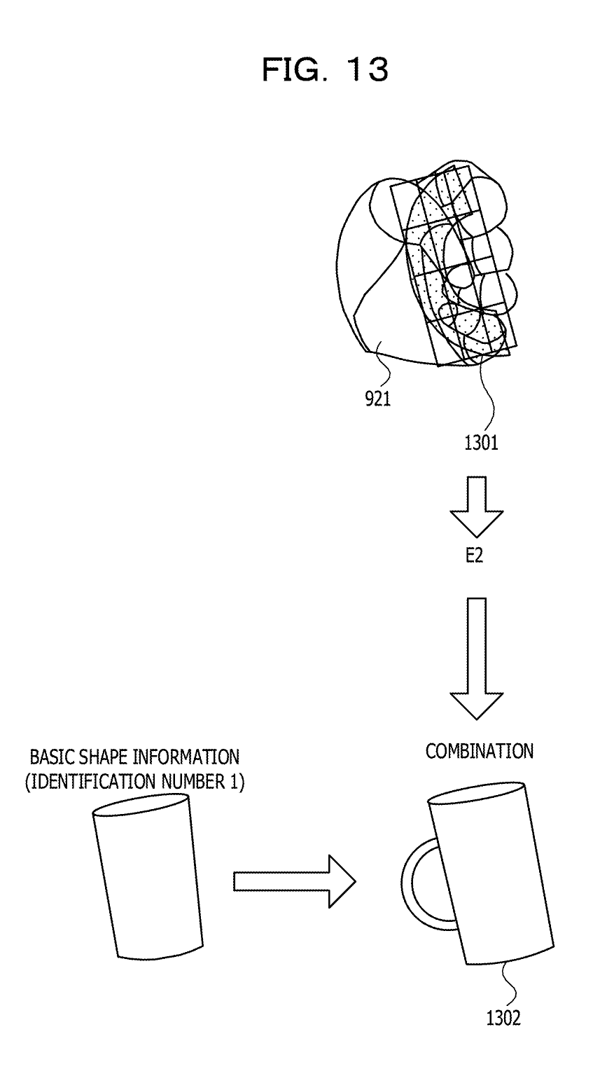

FIG. 13 is a diagram illustrating the overview of combination processing. In the example of FIG. 13, a state is illustrated in which the handle is seen inside the hand model 921. When a round handle is held by the hand of the user 160, the shape of the inside surface of the hand model 921 becomes a shape 1301 corresponding to the round handle. Therefore, the hidden object shape identification unit 808 identifies the handle model having the identification number E2 as the handle model having the outside surface the shape of which is similar to the shape of the inside surface of the hand model 921.

When the hidden object shape identification unit 808 identifies the handle model having the identification number E2, the object combination unit 809 generates a combination object 1302 by combining the identified hand model and the basic shape information that has been notified from the contact determination unit 804.

When the object combination unit 809 generates the combination object 1302, the second object matching unit 810 extracts an object model similar to the combination object 1302 as an object distinguishing result.

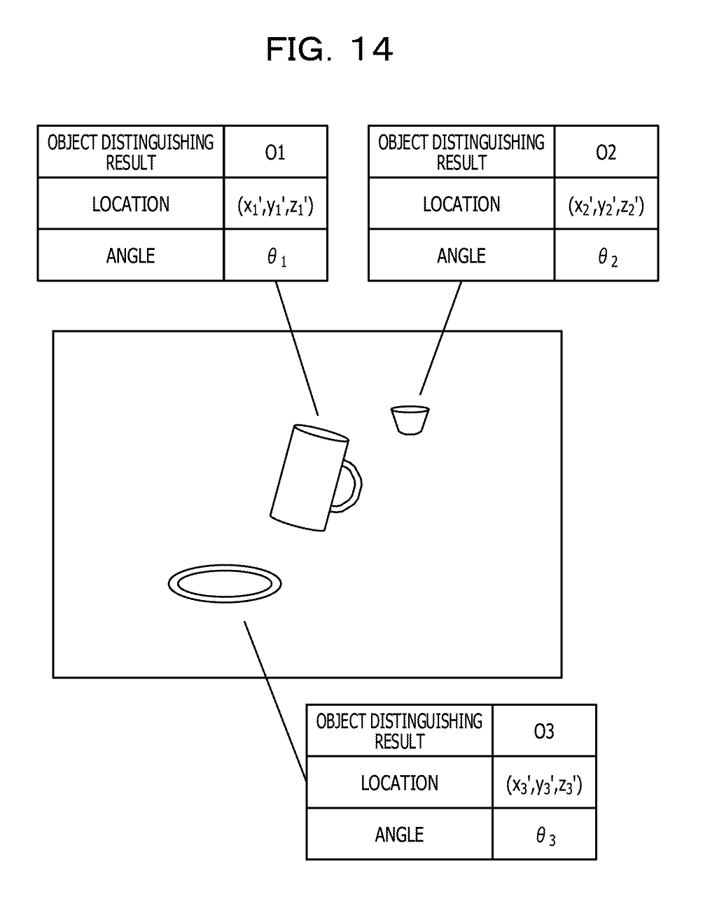

FIG. 14 is a diagram illustrating examples of an object distinguishing result, location information, and angle information at the time when the hand is in contact with an object. As illustrated in FIG. 14, the second object matching unit 810 outputs distinguishing information “O1” as an object distinguishing result of the glass 170. In addition, the second object matching unit 810 outputs “(x₁′,y₁′,z₁′)” as location information of the glass 170 and outputs “θ1” as angle information of the glass 170.

As described above, the object distinguishing unit 210 distinguishes the object by identifying the shape of area hidden by the hand based on the shape of the hand and generating a combination object by combining the identified shape of the hidden area and the basic shape information. Therefore, even when the handle of the glass 170 is hidden by the hand of the handle, the glass 170 may be correctly distinguished in real time.

<Flow of the Object Distinguishing Processing>

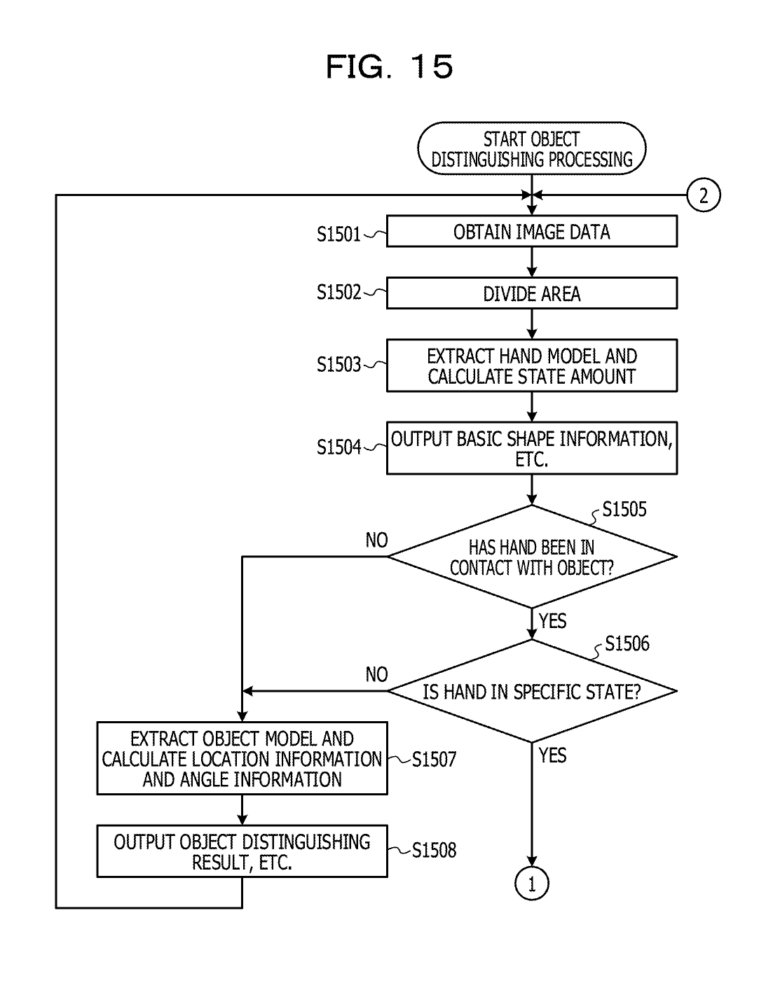

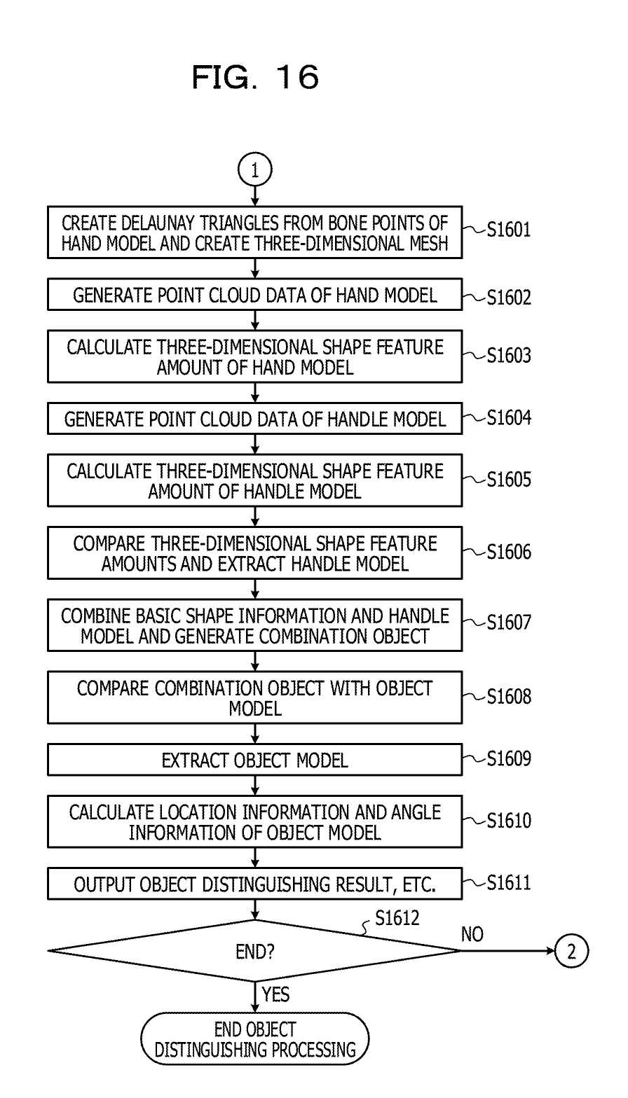

The whole flow of the object distinguishing processing by the object distinguishing unit 210 is described with reference to FIGS. 15 and 16. FIGS. 15 and 16 illustrates the first and the second flowcharts of the object distinguishing processing. When the user 160 takes a seat on the chair 151, the flowchart illustrated in FIG. 15 is executed.

In Step S1501, the image data obtaining unit 801 obtains distance image data that has been measured by the distance measurement apparatus 120 and RGB image data that has been captured by the imaging apparatus 121.

In Step S1502, the area division unit 802 detects objects and a hand based on the RGB image data that has been notified from the image data obtaining unit 801, and extracts areas of the detected objects and hand.

In Step S1503, the hand shape recognition unit 806 extracts a hand model and calculates the state amount of the hand model, based on the distance image data of the area of the hand.

In Step S1504, the object detection unit 803 notifies the contact determination unit 804 of pieces of basic shape information, pieces of location information, and pieces of angle information, based on the distance image data of the areas of the objects.

In Step S1505, the contact determination unit 804 determines whether the hand of the user 160 is in contact with any one of the objects on the table 150, based on the state amount of the hand model, and the pieces of basic shape information, the pieces of location information, and the pieces of angle information of the objects.

In Step S1505, when the contact determination unit 804 determines that the hand of the user 160 is not in contact with any one of the objects on the table 150 (No in Step S1505), the flow proceeds Step S1507. In addition, in Step S1506, when the contact determination unit 804 determines that the hand of the user 160 is in contact with any one of the objects on the table 150 (Yes in Step S1505), the flow proceeds Step S1506.

In Step S1506, the contact determination unit 804 determines whether the hand of the user 160 is in a specific state (state in which the object is held by the hand), based on the state amount of the hand model. In Step S1506, when the contact determination unit 804 determines that the hand of the user 160 is not in the specific state (state in which the object is not held by the hand) (No in Step S1506), the flow proceeds to Step S1507.

In Step S1507, the first object matching unit 805 extracts object models, based on the pieces of basic shape information, the pieces of location information, and the pieces of angle information. In addition, the first object matching unit 805 calculates pieces of location information and pieces of angle information of the extracted object models.

In Step S1508, the first object matching unit 805 outputs the extracted object models to the object state estimation unit 220 as object distinguishing results and performs output of the calculated pieces of location information and pieces of angle information, and the flow returns to Step S1501.

In addition, in Step S1506, when the contact determination unit 804 determines that the hand of the user 160 is in the specific state (state in which the object is held by the hand) (Yes in Step S1506), the flow proceeds to Step S1601 of FIG. 16.

In Step S1601 of FIG. 16, the mesh creation unit 807 creates a three-dimensional mesh by generating Delaunay triangles from bone points of the hand model.

In Step S1602, the mesh creation unit 807 generates point cloud data of the hand model, based on the three-dimensional mesh that has been created based on the hand model.

In Step S1603, the mesh creation unit 807 calculates a three-dimensional shape feature amount of the inside surface of the hand model, based on the generated point cloud data of the hand model.

In Step S1604, the mesh creation unit 807 reads each handle model included in the handle model table 600 and generates point cloud data of the handle model.

In Step S1605, the mesh creation unit 807 calculates a three-dimensional shape feature amount of the outside surface of the handle model, based on the generated point cloud data.

In Step S1606, the hidden object shape identification unit 808 compares the three-dimensional shape feature amount of the hand model with the three-dimensional shape feature amount of each of the handle models. As a result, the hidden object shape identification unit 808 extracts a handle mode having an outside surface the shape of which is similar to the shape of the inside surface of the hand model, as a hidden object distinguishing result.

In Step S1607, the object combination unit 809 generates a combination object using the basic shape information and the hidden object distinguishing result.

In Step S1608, the second object matching unit 810 compares combination object information on the generated combination object with each of the object models included in the object model table 700. In Step S1609, the second object matching unit 810 extracts an object model that is the most similar to the combination object information, as an object distinguishing result.

In Step S1610, the second object matching unit 810 calculates location information indicating the location and angle information indicating the angle of the extracted object model when the extracted object model is determined to be the most similar to the combination object information.

In Step S1611, the second object matching unit 810 outputs the object distinguishing result, the location information, and the angle information of the extracted object model to the object state estimation unit 220.

In Step S1612, the image data obtaining unit 801 determines whether the object distinguishing processing ends. In Step S1612, when the image data obtaining unit 801 determines that the object distinguishing processing is continued (No in Step S1612), the flow returns to Step S1501.

In addition, in Step S1612, when the image data obtaining unit 801 determines that the object distinguishing processing ends (Yes in Step S1612), the object distinguishing processing ends. For example, when the user 160 has left the seat, in the image data obtaining unit 801, the object distinguishing processing ends.

As apparent from the above description, in the object distinguishing unit 210 according to the first embodiment, the shape of an area hidden by the hand is identified and an object is distinguished, so that even when a part of the object is hidden by the hand, the object may be correctly distinguished in real time.

### Second Embodiment

In the above first embodiment, the projector camera system 100 including the distance measurement apparatus 120 and the imaging apparatus 121 is described. However, as long as an object and a hand are detected based on distance image data, the imaging apparatus 121 may not be included in the projector camera system 100.

In addition, in the above-described first embodiment, the distance measurement apparatus 120, the imaging apparatus 121, and the projector apparatus 130 are provided in the housing 110 of the lighting device attached to the ceiling. However, provision of the distance measurement apparatus 120, the imaging apparatus 121, and the projector apparatus 130 is not limited to such an example.

In addition, in the above-described first embodiment, as hidden objects, the handle models are stored in the handle model table 600, but a hidden object other than the handle models may be stored.

In addition, in the above-described first embodiment, the projection range of the projector apparatus 130 is the specific area including the upper surface of the table 150, but the projection range may be changed depending on the location of each distinguished object.

In addition, in the above first embodiment, the case is described in which the projector camera system 100 is applied to a store such as a restaurant or the like, but the projector camera system 100 may be applied to a store other than the restaurant.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. An apparatus for object identification comprising:
a memory; and
a processor coupled to the memory and configured to
execute a determination process that includes determining whether a hand is in contact with an object,
execute an identification process that includes identifying a first shape of an area of the object hidden by the hand in accordance with a second shape of the hand when the hand is determined to be in contact with the object in the determination process, and
execute a distinguishing process that includes distinguishing the object based on the first shape identified by the identification process.

2. The apparatus according to claim 1, wherein
the identification process includes identifying a third shape of an area of a part of the object as the first shape of the area of the object hidden by the hand based on a result of a comparison between a feature amount indicating the third shape of the area of the part of the object and a feature amount indicating the second shape of the hand that is in contact with the object.

3. The apparatus according to claim 1, wherein
the identification processing includes identifying the first shape of the hidden area of the object when the hand is determined to be in contact with the object in the determination processing, and to be in the state of holding the object.

4. The apparatus according to claim 1, wherein
the distinguishing processing includes distinguishing the object based on a shape obtained by combining a fourth shape of a not-hidden area of the object with which the hand is determined to be in contact and the third shape of the area of the part of the object identified in the identification processing.

5. The apparatus according to claim 1, wherein
the object is distinguished based on an object model indicating the object when the hand is determined not to be in contact with the object in the determination processing.

6. A method performed by a computer for object identification, the method comprising:
executing, by a processor of the computer, a determination process that includes determining whether a hand is in contact with an object,
executing, by the processor of the computer, an identification process that includes identifying a first shape of an area of the object hidden by the hand in accordance with a second shape of the hand when the hand is determined to be in contact with the object in the determination processing, and
executing, by the processor of the computer, a distinguishing process that includes distinguishing the object based on the first shape identified by the identification process.

7. A non-transitory computer-readable storage medium for storing a program for object identification, the program causing a computer to execute a process, the process comprising:
executing a determination process that includes determining whether a hand is in contact with an object,
executing an identification process that includes identifying a first shape of an area of the object hidden by the hand in accordance with a second shape of the hand when the hand is determined to be in contact with the object in the determination processing, and
executing a distinguishing process that includes distinguishing the object based on the first shape identified by the identification process.
